(19) United States
(12) Patent Application Publication
(10) Pub. No.: US 2020/0181355 A1
(43) Pub. Date: Jun. 11, 2020

(54) COMPOSITE FLAME RETARDANT AND POLYURETHANE MATERIALS COMPRISING THE SAME

(71) Applicant: COVESTRO DEUTSCHLAND AG, Leverkusen (DE)

(72) Inventors: Chenxi Zhang, Shanghai (CN); Liang Xue, Shanghai (CN)

(21) Appl. No.: 16/333,865

(22) PCT Filed: Sep. 27, 2017
(86) PCT No.: PCT/EP2017/074511

§ 371 Date: Mar. 15, 2019

(30) Foreign Application Priority Data
Sep. 30, 2016 (CN) 201610875676.4

(51) Int. Cl. C08K 3/04; C08L 75/04; C08K 7/24; C08K 5/526; C08K 5/523; C08G 18/32

(52) U.S. Cl. CPC C08K 3/04; C08L 75/04; C08K 7/24; C08K 5/526; C08G 2101/0025; C08G 18/3203; C08K 2201/005; C08L 2201/02; C08K 5/523

(57) ABSTRACT

The present invention relates to a composite flame retardant comprising: (a) an expandable graphite; (b) a liquid poly-functional amino resin polyol having a functionality of from 3 to 6 and a hydroxyl value of from 120 to 500 mg KOH/g; (c) optionally a liquid phosphate flame retardant; and (d) a wetting agent. The present invention also relates to the use of said composite flame retardant in the preparation of polyurethane materials, to polyurethane materials comprising said composite flame retardant and a process for the preparation thereof.

The present invention relates to a composite flame retardant, in particular a composite flame retardant comprising a liquid polyfunctional amino resin polyol and an expandable graphite, to the use of said composite flame retardant in the preparation of polyurethane materials, and to polyurethane materials comprising said composite flame retardant and a process for the preparation thereof.

Polyurethane materials are those prepared from polyhydroxy compounds and isocyanates as raw materials. These polyurethane materials are excellent in physical and mechanical properties, electrical properties, acoustic properties and chemical resistance. Therefore, they are widely used in the fields including chemical industry, transportation, construction and the like.

Many countries have enacted legislations to establish fire-retardant standards for building materials. For example, in France the polyurethane materials used in the building structures should meet the M1-rating (M1 test) in accordance with Norme Francaise NF P 92-501, and in Germany they should fulfill Class B1 (B1 test) of building materials as prescribed under DIN-4102-1:1981-05. In order to meet the requirements for flame retardancy of polyurethane materials, a variety of methods have been developed.

Chinese patent application CN 1724577A discloses a method for producing polyurethane foams, in which an expandable graphite is used as a flame retardant. A solid expandable graphite used as a flame retardant in the production process, however, would cause a sharp increase in the viscosity of the mixture when mixed into a polyol component, resulting in delamination and precipitation phenomena, which are unfavorable in a large-scale automatic production process, e.g. with regard to precise measurement of initial weight.

Therefore, there is still a need for a graphite-based flame retardant for polyurethane materials, which will not cause a sharp increase in the viscosity or show delamination and precipitation phenomena when mixed into a polyol component and which is suitable for use in a large-scale automatic production process.

It is an object of the present invention to provide a uniformly-dispersed composite flame retardant comprising:
(A) an expandable graphite;
(B) a liquid polyfunctional amino resin polyol having a functionality of from 3 to 6 and a hydroxyl value of from 120 to 500 mgKOH/g;
(C) optionally a liquid phosphate flame retardant; and
(D) a wetting agent.

The composite flame retardant of the present invention can be used for the preparation of polyurethane materials. The composite flame retardant does not cause a sharp increase in viscosity or delamination and precipitation phenomena when mixed into a polyol component used for the preparation of polyurethane materials and is suitable for precise measurement in large-scale automatic production processes.

It is another object of the present invention to provide a process for the preparation of polyurethane materials comprising the above-described composite flame retardant, the process comprising:
(A) mixing the composite flame retardant of the present invention into a polyol component for preparing polyurethane materials; and
(B) adding an isocyanate component to the mixture of the polyol component obtained in (a).

The present invention also provides polyurethane materials which are prepared from a polyurethane composition comprising:
A) an isocyanate component comprising one or more polyisocyanates;
B) a polyol component comprising one or more polyols;
C) a composite flame retardant comprising:
(a) an expandable graphite;
(b) a liquid polyfunctional amino resin polyol having a functionality of from 3 to 6 and a hydroxyl value of from 120 to 500 mgKOH/g;
(c) optionally a liquid phosphate flame retardant; and
(d) a wetting agent.

The composite flame retardant according to the invention, comprises, in each case based on the total weight of the composite flame retardant (100% by weight):
(A) 10 to 55% by weight, preferably 20 to 50% by weight of an expandable graphite;
(B) 10 to 60% by weight, preferably 20 to 50% by weight, more preferably 30 to 40% by weight of a liquid polyfunctional amino resin polyol having a functionality of from 3 to 6 and a hydroxyl value of from 120 to 500 mg KOH/g;
(C) 0 to 40% by weight, preferably 10 to 30% by weight of a liquid phosphate flame retardant; and
(D) 0.1 to 5% by weight of a wetting agent.

In the present invention, the “hydroxyl value” refers to the value determined according to DIN 53240-1 (June 2013).

The main component of the composite flame retardant of the present invention is a mixture of an expandable graphite, a liquid polyfunctional amino resin polyol and optionally a liquid phosphate flame retardant.

In the present invention, the term “expandable graphite” refers to an expandable delaminated graphite having an expansion ratio of from 100 to 300 (determined according to GB/T-10698-1989).

In one embodiment of the present invention, the particle size of the expandable graphite is from 20 to 100 meshes, preferably from 30 to 90 meshes, more preferably from 50 to 80 meshes (determined according to GB/T-10698-1989).

In the present invention, the term “polyfunctional amino resin polyol” refers to an amino resin in which the methyl group of the amino resin is exchanged with a hydroxy group by an ether exchange process. In one embodiment of the present invention, the polyfunctional amino resin polyol has a functionality of from 3 to 6 and a hydroxyl value of from 120 to 500 mg KOH/g, and a viscosity of from 10,000 to 20,000 mPa.S/25 ° C., measured according to ASTM D4878. In a preferred embodiment of the present invention, non-limiting examples of the polyfunctional amino resin polyol include, but are not limited to, those of the following structural formula:

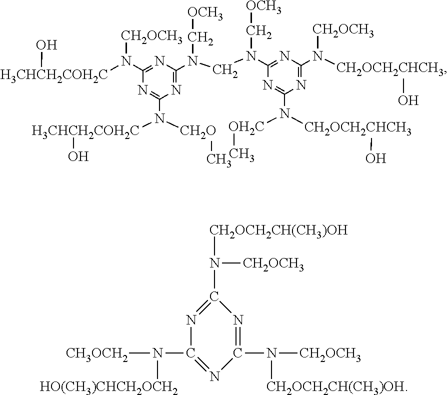

In a preferred embodiment of the present invention, non-limiting examples of the liquid phosphate flame retardant include tri(polyoxyalkylene)phosphate, tri(polyoxyalkylene)phosphite, tris(dipropylene glycol)phosphite (commonly known as P430), dimethyl methylphosphate (DMMP), dimethyl propylphosphonate (DMPP), diethyl ethylphosphate (DEEP), triethyl phosphate, tricresyl phosphate (TPP), etc.

The amount of the liquid phosphate flame retardant to be added in the composite flame retardant of the present invention can be adjusted according to the actual requirements. In a preferred embodiment of the present invention, the liquid phosphate flame retardant is added in an amount of 0 to 60% by weight, preferably 10 to 50% by weight, more preferably 40 to 50% by weight, based on the total weight of the composite flame retardant (100% by weight).

According to the present invention, it is necessary to add a wetting agent in the composite flame retardant of the present invention. Surprisingly, it was found that a uniformly-dispersed composite flame retardant system can be obtained without delamination by adding a wetting agent.

Preferably, the wetting agent suitable for use in the process of the present invention comprises one or more components selected from the following groups of compounds:
(1) alkyl ammonium salts of high molecular weight polycarboxylic acid polymers, such as Disperbyk® 112, Disperbyk® 115, Disperbyk® 116, Disperbyk® 140, Disperbyk® 142, Disperbyk® 160, Disperbyk® 161, Disperbyk® 162, Disperbyk® 168, Disperbyk® 169, Disperbyk® 170, Disperbyk® 171, Disperbyk® 174, Disperbyk® 182, Disperbyk® 183, Disperbyk® 184, Disperbyk® 190, Disperbyk® 191, Disperbyk® 2000, and Disperbyk® 2001 available from BYK Chemie, Germany;
(2) alkyl ammonium salts of low molecular weight polycarboxylic acid polymers, such as Disperbyk® 107, Disperbyk® 108, and Disperbyk® 130 available from BYK Chemie, Germany;
(3) solutions of polyamides and polycarboxylates, such as Anti-Terra® 204 and Anti-Terra® 205;
(4) alkyl ammonium salts of high molecular weight copolymers, such as BYK® 9076 and BYK® 9077;
(5) high molecular weight block copolymers containing pigment affinity groups; and
(6) structured acrylate copolymers containing pigment affinity groups.

In a preferred embodiment of the present invention, the amount of the wetting agent to be added is 0.1 to 5% by weight, preferably 0.2 to 3% by weight, more preferably 0.2 to 2% by weight, based on the total weight of the composite flame retardant.

The composite flame retardant of the present invention can be prepared by conventional methods. In a preferred embodiment of the present invention, the preparation process comprises the steps of (1) adding an expandable graphite, optionally a liquid phosphate flame retardant, a liquid polyfunctional amino resin polyol and a wetting agent in any order, and (2) uniformly mixing them.

In another aspect, the present invention also relates to the use of said composite flame retardant for the preparation of polyurethane materials. The composite flame retardant will not cause a sharp increase in viscosity or delamination and precipitation phenomena when mixed into a polyol component for the preparation of polyurethane materials and thus is suitable for precise use in large-scale automatic production processes.

In yet another aspect, the present invention also provides polyurethane materials which are prepared from a polyurethane composition comprising:
A) an isocyanate component comprising one or more polyisocyanates;
B) a polyol component comprising one or more polyols; and
C) the composite flame retardant as described above.

In some embodiments of the present invention, the composite flame retardant is used in an amount of from 20 to 70% by weight, preferably from 25 to 60% by weight, more preferably from 25 to 50% by weight, based on the total weight of the polyol component (100% by weight).

The polyol component suitable for the preparation of polyurethane materials of the present invention is not particularly limited and may be any conventional polyols for the preparation of polyurethane materials. In one embodiment of the present invention, non-limiting examples of the polyols include polyether polyols, such as polyether polyols having a functionality of from 2 to 6 and a hydroxyl value of from 18 to 800 mgKOH/g formed from propylene glycol, ethylene glycol, glycerol, trimethylolpropane, pentaerythritol, sucrose, sorbitol, ethylenediamine, or toluene diamine as starter; polyester polyols, for example, polyester polyols having a functionality of from 2 to 4 and a hydroxyl value of from 50 to 500 mgKOH/g formed by condensation of a main chain structure of adipic acid and/or phthalic anhydride with ethylene glycol, propylene glycol, glycerol, trimethylolpropane, 1,4-butanediol, 1,6-hexanediol or pentanediol. Other polyols known in polyurethane chemistry may be used, preferably in admixture with above polyols.

Other additives such as polymerization catalysts, antioxidants, and blowing agents may also be added to the polyol component. Those skilled in the art could readily determine specific polymerization catalysts, antioxidants, blowing agents, and the like, and the amounts thereof to be added in the polyol component according to the individual applications in combination with their professional knowledge.

In a preferred embodiment of the present invention, non-limiting examples of the polymerization catalysts include 1,4-diazonium(2,2,2-cyclooctane)(triethylenediamine DABCO), N, N, N′, N′, N″-pentamethyl-diethyltriamine(PMDETA), N,N-dimethylcyclohexylamine (DMCHA), N,N-dimethylbenzylamine, N,N′-tetramethylethylenediamine (TMEDA), N-dimethylaminopropylamine (DMAPA) AminZ, N,N-dimethylethanolamine (DMEA), 2,4,6-tris(dimethylaminomethyl)phenol, N-ethylmorpholine (NEM), bis-N, N′-dimethylaminoethyl ether, dibutyltin dilaurate (DBTDL), and the like.

Non-limiting examples of the blowing agents include water, hydrocarbons (e.g., n-pentane and cyclopentane), hydrogenated fluorocarbons (e.g., R-245fa, R-134a, R-365, hydrogenated Freon, and R-141b) or a mixture thereof in any proportion.

In addition to the above-described composite flame retardant, the polyurethane composition may also comprise conventional flame retardants commonly used in the art, and the amount thereof may be determined according to the actual requirements.

In the present invention, the isocyanate component may be conventional polyisocyanates used for preparing polyurethane materials in the art. In one embodiment of the present invention, non-limiting examples of the polyisocyanates include 4,4′-diphenylmethane diisocyanate or diphenylmethane diisocyanate-related modified products, 2,4-tolylene diisocyanate, and 2,6-toluene diisocyanate.

In a preferred embodiment of the present invention, the polyisocyanate has an NCO% content of 18.0 to 36.0% (determined according EN ISO 11909 (May 2007), values@25° C.

In yet another aspect, the present invention also relates to a process for the preparation of the above-mentioned polyurethane materials, comprising
(a) mixing the composite flame retardant of the present invention into a polyol component for preparing polyurethane materials; and
(b) adding an isocyanate component to the mixture of the polyol component obtained in (a).

The present invention therefore also relates to a polyol component comprising above described composite flame retardant composition.

Unlike the use of a solid expandable graphite, the amount of the composite flame retardant to be added in the polyol component, preferably polyol, of the present invention depends on the particular application requirements.

In the course of preparing polyurethane materials comprising the composite flame retardant of the present invention, there is no need to subject the reaction feedstock to any pretreatment. In a preferred embodiment of the present invention involving the preparation of a non-foamed polyurethane material, however, the polyol component is subjected to a dehydration treatment to prevent the generation of cells in the polymer so as to improve the quality of the products. The conditions of the dehydration treatment are not particularly limited and may be any dehydration treatment conditions. In a preferred embodiment of the present invention, the polyol component is dehydrated at 110° C. and 0.5 mbar vacuum for 0.5 to 2 hours, or alternatively, 2 to 5% of a desiccant is added, and then the dehydrated polyol component is mixed with the composite flame retardant of the present invention, a catalyst, optionally an antioxidant, and the like to form a mixture of the polyol component.

In some embodiments of the present invention, the polyol composition may be mixed with the isocyanate component and then reacted in the mold or in situ.

The composite flame retardant of the invention is a liquid product. Thus, it can be conveniently processed and metered while avoiding the common phenomena of increase in viscosity, delamination, precipitation, or of being inconvenient to be processed or metered that occur when a solid expansible graphite is mixed into a polyol component. When the composite flame retardant of the invention is mixed into the polyol component, it can be stirred artificially or mechanically.

The polyurethane materials provided by the present invention may have a wide density range and can be any foam to solid materials (with a density range of from 0.2 to 1.2 g/cm³), preferably rigid polyurethane foams, such as bulk rigid polyurethane foams, rigid polyurethane foam sheets with metallic and non-metallic surfaces, reactive injection-molded materials, and sprayed rigid polyurethane foams.

### EXAMPLES

Hereinafter, the present invention will be further illustrated in view of the examples. The following examples are for illustrative purpose only and should not be construed as limiting the invention. Modifications and adjustments made by those skilled in the art in accordance with the present invention in practical applications are still within the scope of the present invention.

### Preparation Example 1 of the Composite Flame Retardant

Into a three-necked flask equipped with an electric stirrer, 30 g of a liquid polyfunctional amino resin polyol (EDS-5083L; Jiangsu Changneng Energy-saving New Material Technology Co., Ltd), 0.4 g of a wetting agent BYK® 9076, 20 g of dimethyl methylphosphate (DMMP), and 50 g of an expandable graphite 100 (3494 Asbury Carbons) were added. The materials were mixed uniformly to obtain a composite flame retardant.

### Preparation Example 2 of the Composite Flame Retardant

Into a three-necked flask equipped with an electric stirrer, 30 g of a liquid polyfunctional amino resin polyol (EDS-5083L; Jiangsu Changneng Energy-saving New Material Technology Co., Ltd), 1.0 g of a wetting agent BYK® 9077, 30 g of dimethyl methylphosphate, and 40 g of an expandable graphite 300 were added. The materials were mixed uniformly to obtain a composite flame retardant.

### Preparation Example 3 of the Composite Flame Retardant

Into a three-necked flask equipped with an electric stirrer, 40 g of a liquid polyfunctional amino resin polyol (EDS-5083L; Jiangsu Changneng Energy-saving New Material Technology Co., Ltd), 0.4 g of a wetting agent BYK® 9076, 20 g of dimethyl methylphosphate, and 50 g of an expandable graphite 300 were added. The materials were mixed uniformly to obtain a composite flame retardant.

Table 1 below clearly shows the composition of the composite flame retardants (LFR-1 to LFR-3) obtained in Preparation Examples 1-3 of the present invention.

TABLE 1

| | | Components | | |
|---|---|---|---|---|
| | | LFR-1 | LFR-2 | LFR-3 |
| Liquid polyfunctional | Parts by weight | 30 | 30 | 40 |
| amino resin polyol | | | | |
| Wetting agent | Parts by weight | 0.4 | 1 | 0.4 |
| DMMP | Parts by weight | 20 | 30 | 20 |
| Expandable graphite | Parts by weight | 50 | 40 | 50 |
| Total weight | | 100.4 | 101 | 110.4 |

Table 2 below shows the formulation of rigid polyurethane foam sheets comprising polyols. The components used in Table 2 are described as follows:
Polyol B: DC380, available from Dongchang Company;
Polyol C: PS3152, available from Jinling Stepan Company;
Surfactant: L6920, available from Momentive Company;
Catalyst: PU1792, available from Dajiang Chemical Company;
Reactive flame retardant: IXOL B251, available from Solvay Company; and
Additive flame retardant: TEP, available from Jacques Chemical Company.

TABLE 2
Formulations of polyurethane foams

| | | Examples | | | |
|---|---|---|---|---|---|
| | | 4 | 5 | 6 | 7 |
| Polyol B | Parts by weight | 30 | 50 | 40 | 20 |
| Polyol C | Parts by weight | 40 | 30 | 40 | 80 |
| Surfactant | Parts by weight | 5.8 | 5.8 | 5.8 | 5.8 |
| Water | Parts by weight | 1.4 | 1.4 | 1.4 | 1.4 |
| Catalyst | Parts by weight | 4.8 | 4.8 | 4.8 | 4.8 |
| Reactive flame retardant | Parts by weight | 30 | 25 | 0 | 25 |
| Additive flame retardant | Parts by weight | 40 | 35 | 0 | 0 |
| Composite flame retardant | Parts by weight | 0 | 0 | 0 | 30 |
| LFR-1 | | | | | |
| Composite flame retardant | Parts by weight | 0 | 40 | 0 | 0 |
| LFR-2 | | | | | |
| Composite flame retardant | Parts by weight | 0 | 0 | 50 | 0 |
| LFR-3 | | | | | |

The formulation used in Example 4 is a standard commercial formulation without the composite flame retardant of the present invention. The formulations used in Examples 5-7 are those with the composite flame retardant of the present invention.

Table 3 below shows the mechanical properties and flame retardancy of the polyurethane foams comprising the composite flame retardant of the present invention.

In Table 3, Examples 4-7 were prepared using the polyols of Examples 4-7 shown in Table 2, respectively. As can be seen from Table 3, the oxygen indices of Examples 5, 6 and 7 were significantly higher than the oxygen index of Example 4, indicating that the flame retardancy of polyurethane foams containing the composite flame retardant of the present invention were remarkably increased, while the good mechanical and physical properties were still retained.

Mechanical properties and flame retardancy were determined as follows:
Test method for densities: DIN EN ISO 845 (2009)
Test method for the thermal conductivity DIN 52612-2:1984-06@10° C.
Test method for the closed porosity of foam (closed cell content): ASTM D2856-94
Test method for the compressive strength η: DIN 53421:1984-06
Test method of the dimensional stability of the foam: GB/T 8811-2008
Test method for the Oxygen index: GB/T 2406.1-2008

TABLE 3
Mechanical property and flame retardancy of polyurethane foams

| | | Formulation No. | | | |
|---|---|---|---|---|---|
| | | 4 | 5 | 6 | 7 |
| Mold temperature | ° C. | 55-65 | 55-65 | 55-65 | 55-65 |
| Bulk density of molded | kg/m³ | 50 | 50.5 | 50.2 | 50.6 |
| foam | | | | | |
| Core density of molded | kg/m³ | 46 | 46.6 | 46.1 | 46.5 |
| foam | | | | | |
| Thermal conductivity | mW/m*K | 21.04 | 21.51 | 22.48 | 21.62 |
| Closed porosity of foam | Vol % | 97.27 | 97.79 | 96.0 | 98.39 |
| Compressive strength η | MPa | 0.278 | 0.28 | 0.281 | 0.27 |
| ⊥ | MPa | 0.193 | 0.190 | 0.192 | 0.2 |
| ⊥ | MPa | 0.169 | 0.164 | 0.168 | 0.17 |
| Dimensional stability of | Vol % | 0.13 | −0.15 | 0.07 | 0.21 |
| foam at −30° C. | | | | | |
| 70° C. | Vol % | 1.22 | 1.52 | 1.42 | 1.32 |
| 70° C., 95% rh | Vol % | 3.31 | 3.47 | 3.52 | 3.54 |
| Oxygen index | | 27.6 | 33.2 | 32.9 | 33.8 |

1. A uniformly-dispersed composite flame retardant comprising:
(a) an expandable graphite;
(b) a liquid polyfunctional amino resin polyol having a functionality of from 3 to 6 and a hydroxyl number of from 120 to 500 mg KOH/g;
(c) optionally a liquid phosphates flame retardant; and
(d) a wetting agent.

2. The composite flame retardant according to claim 1, wherein the expandable graphite has an expansion ratio of 100 to 300 and a particle size of 20 to 100 meshes.

3. The composite flame retardant according to claim 1, wherein the liquid phosphate flame retardant is selected from the group consisting of: tris(polyoxyalkylene) phosphate, tris(polyoxyalkylene) phosphite, tris(dipropylene glycol) phosphite, dimethyl methylphophate, dimethyl propylphosphate, diethyl ethylphosphate, triethyl phosphate and tricresyl phosphate, and combinations thereof.

4. The composite flame retardant according to claim 1, wherein the wetting agent is selected from the group consisting of: alkyl ammonium salts of high molecular weight polycarboxylic acid polymers, alkyl ammonium salts of low molecular weight polycarboxylic acid polymers, polycarboxylic acid salts of polyamine amides, alkyl ammonium salts of high molecular weight copolymers, high molecular weight block copolymers containing pigment affinity groups, and structured acrylate copolymers containing pigment affinity groups.

5. A process comprising:
preparing polyurethane materials utilizing the composite flame retardant according to claim 1.

6. Polyurethane materials prepared from a polyurethane composition comprising:
A) an isocyanate component comprising one or more polyisocyanates;
B) a polyol component comprising one or more polyols; and
C) a composite flame retardant according to claim 1.

7. The polyurethane materials according to claim 6, wherein the polyurethane materials are rigid polyurethane foams.

8. The polyurethane materials according to claim 6, wherein the composite flame retardant is used in an amount of from 20 to 70% by weight based on the weight of the polyol component.

9. The polyurethane materials according to claim 6, wherein the polyol component further comprises polymerization catalysts, antioxidants, blowing agents and combinations thereof.

10. A process for preparing polyurethane materials comprising the composite flame retardant according to claim 1, said process comprising:
(a) mixing the composite flame retardant into a polyol component for the preparation of polyurethane materials; and
(b) adding an isocyanate component to the mixture of the polyol component obtained in (a).
